(19) United States
(12) Patent Application Publication
(10) Pub. No.: US 2025/0322636 A1
(43) Pub. Date: Oct. 16, 2025

(54) NEW SYNTAX ELEMENTS AND OPTIMIZATION METHODS FOR ORTHOATLAS

(71) Applicants: SONY GROUP CORPORATION, Tokyo (JP); Sony Corporation of America, New York, NY (US)

(72) Inventors: Danillo Graziosi, Flagstaff, AZ (US); Alexandre Zaghetto, San Jose, CA (US); Ali Tabatabai, Cupertino, CA (US)

(21) Appl. No.: 18/883,855

(22) Filed: Sep. 12, 2024

Related U.S. Application Data
(60) Provisional application No. 63/632,237, filed on Apr. 10, 2024.

(51) Int. Cl. G06V 10/25; H04N 19/70

(52) U.S. Cl. CPC G06V 10/25; H04N 19/70

(57) ABSTRACT

Improvements to orthoAtlas include: new syntax elements to indicate the mapping method used by orthoAtlas; a method to adjust projection parameters to compensate for compression artifacts in encoded vertex positions; a syntax modification to efficiently encode projection parameters taking advantage of temporal correlation; a method to reduce signaling by using the calculated bounding box to derive projection parameters; and a method to avoid bounding box estimation at decoder side, therefore reducing the decoder complexity.

### CROSS-REFERENCE TO RELATED APPLICATION(S)

This application claims priority under 35 U.S.C. § 119 (e) of the U.S. Provisional Patent Application Ser. No. 63/632,237, filed Apr. 10, 2024 and titled, “NEW SYNTAX ELEMENTS AND OPTIMIZATION METHODS FOR ORTHOATLAS,” which is hereby incorporated by reference in its entirety for all purposes.

### FIELD OF THE INVENTION

The present invention relates to three dimensional graphics. More specifically, the present invention relates to coding of three dimensional graphics.

### BACKGROUND OF THE INVENTION

Meshes are composed of a set of polygons usually describing a surface of a volume. An efficient way to describe the surface properties of a mesh (for instance, its color characteristics) is to generate a texture atlas that maps the properties of the 3D surface onto a 2D surface. However, mapping 3D surfaces onto 2D is a non-trivial problem, and state-of-the-art methods such as UVAtlas from Microsoft resort to time consuming optimizations to find appropriate cuts in the mesh and mapping using surface harmonics. In the latest international point cloud compression standard, texture map images are generated for point clouds using orthographic projections. While they are easy to generate, they are used for point clouds only, so they do not consider the connectivity structure present in meshes.

### SUMMARY OF THE INVENTION

Improvements to orthoAtlas include: new syntax elements to indicate the mapping method used by orthoAtlas; a method to adjust projection parameters to compensate for compression artifacts in encoded vertex positions; a syntax modification to efficiently encode projection parameters taking advantage of temporal correlation; a method to reduce signaling by using the calculated bounding box to derive projection parameters; and a method to avoid bounding box estimation at decoder side, therefore reducing the decoder complexity.

In one aspect, a method programmed in a non-transitory memory of a device comprises implementing at least one of: indicating a mapping method used by orthoAtlas, adjusting projection parameters to compensate for compression artifacts in encoded vertex positions, encoding projection parameters based on temporal correlation, using a calculated bounding box to derive projection parameters and avoiding bounding box estimation at a decoder. Indicating the mapping method includes attributes selected from uv coordinates, face ID, and when no attribute is indicated, connected components are utilized. Adjusting projection parameters includes using projection parameters by searching in 2D to readjust the projection parameters to avoid having values outside of a range or values on top of each other. Encoding projection parameters based on temporal correlation includes copying data from a reference patch. Encoding projection parameters based on temporal correlation includes sending delta information. Adjusting projection parameters includes performing triangle bounding box rasterization. Adjusting projection parameters includes determining if a patch fits in a texture map by determining if there is any overlap with another patch. When the patch is determined to not fit, a spiral search around a current position is implemented to search for a position where the patch fits. Blocks of a plurality of pixels are used in the triangle bounding box rasterization.

In another aspect, an apparatus comprises a non-transitory memory for storing an application, the application for: implementing at least one of: indicating a mapping method used by orthoAtlas, adjusting projection parameters to compensate for compression artifacts in encoded vertex positions, encoding projection parameters based on temporal correlation, using a calculated bounding box to derive projection parameters and avoiding bounding box estimation at a decoder and a processor coupled to the memory, the processor configured for processing the application. Indicating the mapping method includes attributes selected from uv coordinates, face ID, and when no attribute is indicated, connected components are utilized. Adjusting projection parameters includes using projection parameters by searching in 2D to readjust the projection parameters to avoid having values outside of a range or values on top of each other. Encoding projection parameters based on temporal correlation includes copying data from a reference patch. Encoding projection parameters based on temporal correlation includes sending delta information. Adjusting projection parameters includes performing triangle bounding box rasterization. Adjusting projection parameters includes determining if a patch fits in a texture map by determining if there is any overlap with another patch. When the patch is determined to not fit, a spiral search around a current position is implemented to search for a position where the patch fits. Blocks of a plurality of pixels are used in the triangle bounding box rasterization.

In another aspect, a system comprises an encoder configured for: indicating a mapping method used by orthoAtlas, adjusting projection parameters to compensate for compression artifacts in encoded vertex positions, encoding projection parameters based on temporal correlation and using a calculated bounding box to derive projection parameters and a decoder configured for avoiding bounding box estimation. Indicating the mapping method includes attributes selected from uv coordinates, face ID, and when no attribute is indicated, connected components are utilized. Adjusting projection parameters includes using projection parameters by searching in 2D to readjust the projection parameters to avoid having values outside of a range or values on top of each other. Encoding projection parameters based on temporal correlation includes copying data from a reference patch. Encoding projection parameters based on temporal correlation includes sending delta information. Adjusting projection parameters includes performing triangle bounding box rasterization. Adjusting projection parameters includes determining if a patch fits in a texture map by determining if there is any overlap with another patch. When the patch is determined to not fit, a spiral search around a current position is implemented to search for a position where the patch fits. Blocks of a plurality of pixels are used in the triangle bounding box rasterization.

### BRIEF DESCRIPTION OF THE DRAWINGS

FIG. 1 illustrates a diagram of an attribute mapping solution according to some embodiments.

FIG. 2 illustrates a diagram of patch decoding according to some embodiments.

FIG. 3 illustrates a diagram of orthoAtlas UV correction according to some embodiments.

FIG. 4 illustrates images of varying resolution according to some embodiments.

FIG. 5 illustrates a diagram of the orthoAtlas simplification according to some embodiments.

FIG. 6 illustrates a diagram of the orthoAtlas simplification according to some embodiments.

FIG. 7 illustrates a block diagram of an exemplary computing device configured to implement the orthoAtlas optimization methods according to some embodiments.

### DETAILED DESCRIPTION OF THE PREFERRED EMBODIMENT

Described herein are five updates to orthoAtlas, namely: (1) new syntax elements to indicate the mapping method used by orthoAtlas; (2) a method to adjust projection parameters to compensate for compression artifacts in encoded vertex positions; (3) a syntax modification to efficiently encode projection parameters taking advantage of temporal correlation; (4) a method to reduce signaling by using the calculated bounding box to derive projection parameters; and (5) a method to avoid bounding box estimation at the decoder side; therefore, reducing the decoder complexity.

The updates described herein disclose optimal methods to encode texture maps generated by orthoAtlas, namely, more efficient methods to transmit the projection parameters. Described herein are new syntax elements for mapping methods between projection parameters and triangles, coding of projection parameters taking into account temporal correlation, methods to adjust projection parameters to compensate for encoding artifacts of vertex positions, methods to reduce signaling by deriving projection parameters from the decoded bounding box, and methods to reduce decoder complexity by signaling the bounding box.

There used to be a syntax element that indicated the mapping between the triangles on the mesh surface and the projection parameters. For a group of triangles, the orthoAtlas sends projection parameters, so that at the decoder side, given the triangle position in 3D space, the projection parameters are used to obtain the texture coordinates (the position of the RGB in the texture map image). It was also indicated how this would be done-either the UV coordinates were used, the faceID was used or it was derived implicitly using connected components, and a syntax element was sent indicating which method was used.

Previously, orthoAtlas did not know from which attribute to derive the mapping, since the basemesh may have multiple attributes, or not even have an expected attribute (for instance, if mapping chooses face id, but the basemesh does not have it). A syntax element is able to be added in Atlas Sequence Parameter Set (ASPS) to indicate to orthoAtlas which indexes will be used (instead of using mapping syntax element). For example, the syntax element is able to indicate to use attribute #5, and then according to the type of attribute #5 (e.g., uv coordinate, face ID), the derivation will be of that type.

Since the texture coordinates are generated by orthoAtlas in the attributes with index 0, a syntax element is able to be added in ASPS to indicate the attribute index to output the generated texture coordinates. When a texture coordinate is generated, the texture coordinate is put in the output basemesh. The added syntax element is able to indicate the position in the basemesh. The basemesh is a structure that has an array of attributes which indicate which position will have the generated texture coordinates.

To address the bit depth of the generated texture coordinate not being signaled, a syntax element is able to be added in ASPS to indicate the target bit depth generation information only, which may be ignored since actual decoders use values between 0-1.0 rather than quantized values.

The following is a way to solve the attribute mapping issue:

The first two index elements below (index_present_flag and attribute_index) are the syntax elements which indicate which attribute the mapping is coming from. If the index_present_flag is 0, then it is not coming from any input attribute, which means the connected components approach will be utilized and the mapping is derived at the decoder side. If the index_present_flag is present (e.g., not 0), then the index is indicated and based on the index indicated, and the attribute of that index from the basemesh is utilized. If the type of the attribute is uv coordinates, then uv coordinates are used, or if the type is faceID, then the faceID procedure is used.

The output_attribute_index indicates where the generated texture coordinates are saved. The output_bit_depth_minus1 is the bit depth.

Consider the values of V3C Parameter Set (VPS) as indicating the number of attributes from basemesh, e.g., the input of reconstruction, the bit depth of the new attribute generated is indicated with orthoAtlas, not using the VPS value:

The VPS only maps the decoded attributes to what is going to be the INPUT of reconstruction (attributes present in the BASEMESH).

If reconstruction generates new attributes, it may increase the number of attributes for the mesh, which depends on the value for output index, which is limited to 0 . . . . VPS_COUNT (indicate either overwriting an existing attribute, or possibly generating a new one). To indicate the bit depth of the generate attribute, the bitdepth is able to be added in ASPS.

Exemplary orthoAtlas syntax in ASPS is shown:

| | |
|---|---|
| if( asve_projection_textcoord_enable_flag ){ | |
| asve_projection_textcoord_mapping_attribute_index_present_flag u(1) | |
| if( asve_projection_textcoord_mapping_attribute_index_present_flag ) | |
| asve_projection_textcoord_mapping_attribute_index | u(7) |
| asve_projection_textcoord_output_attribute_index | u(7) |
| asve_projection_textcoord_output_bit_depth_minus1 | u(5) |
| asve_projection_textcoord_mapping_method | u(2) |
| asve_projection_textcoord_scale_factor | fl(64) |
| } | |

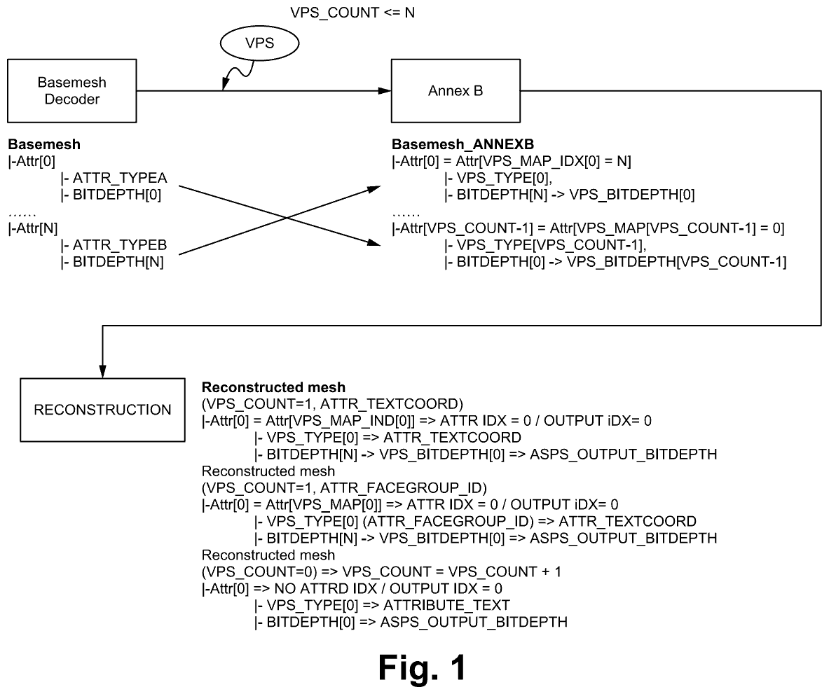

FIG. 1 illustrates a diagram of an attribute mapping solution according to some embodiments. The basemesh has several attributes (0 . . . . N). There is a mapping between the basemesh and Annex B. Annex B indicates which attributes are important or relevant. For example, if the VPS count is 2, then only 0 and 1 are relevant. Additionally, in the VPS, attribute 0 is attribute N in the basemesh, so they are mapped. Attribute 1 is attribute 0 in the basemesh. Thus, there is a mapping between the basemesh and Annex B, which is a stage in the decoding process.

The basemesh is coming from Annex B, which has VPS count (e.g., 2 attributes: 0 and 1), and those attributes are also described by the VPS type and bitdepth.

At reconstruction, texture map generation may occur or not. For example, attribute 0 is used, which is carrying the mapping information. Output on index 0 means it used to have the mapping information, but is replaced with the generated texture coordinates. The type of the input is also checked (e.g., textcoord) which means the uv procedure is utilized. The bitdepth is the bit depth indicated in the ASPS.

In another example, index 0 indicates a facegroup ID, but the output is index 0 to become the texture coordinate.

In another example, if no attributes are indicated, then connected components are utilized.

Texture parameterization generates the projection parameters based on the decimated input, but the geometry may still change because of geometry parameterization and compression. Some sequences are generating UV coordinates outside of the [0-1] range.

To address this issue, the bounding box of the set of triangles is checked using the same projection. If the projection footprint has increased, then (sizeU, sizeV) is increased accordingly, and the (U0, V0) is shifted to compensate for the size increase. Then, around the (0, 0) position is checked if there is any other position where the patch is mostly inside the image and has minimum overlap with other patches. In other words, compensation occurs using the projection parameters by searching in 2D to readjust the projection parameters to avoid having values outside of a range or values on top of each other.

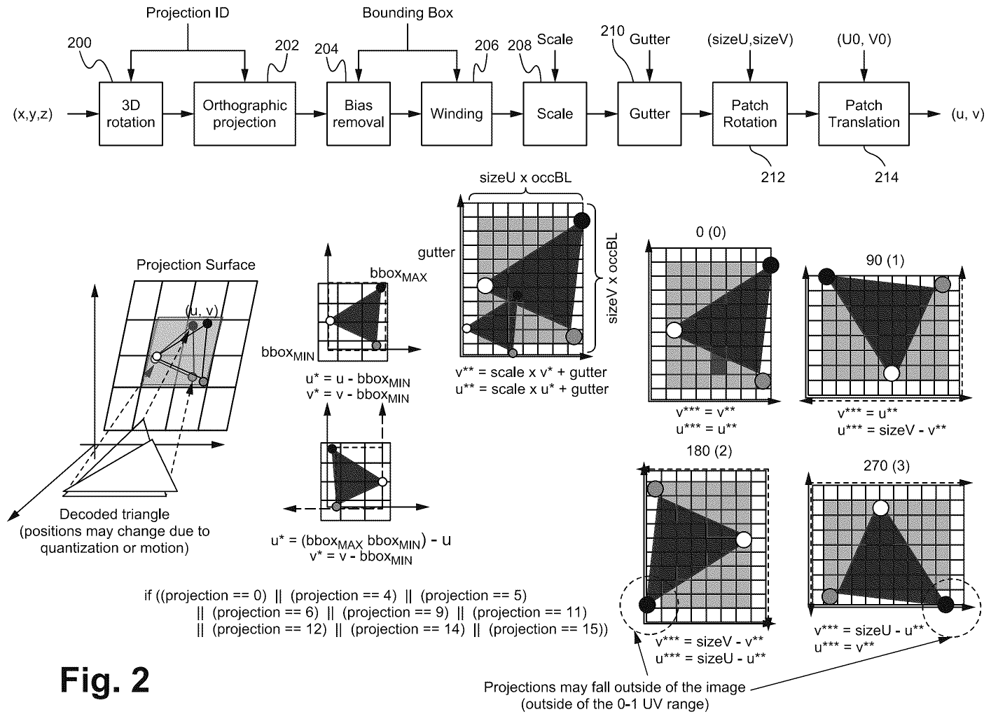

FIG. 2 illustrates a diagram of patch decoding according to some embodiments. In the step 200, before the triangle is projected to the 2D surface, the triangle is rotated. The 3D rotation is able to be implemented in any manner. In the step 202, with a projection ID, a 3D triangle is projected (e.g., using orthographic projection) to the 2D/projection surface.

In the step 204, a 3D bounding box is used to remove the bias. Bias removal is able to be implemented in any manner such as adjusting the location of the triangle within the bounding box.

In the step 206, the winding is modified (if necessary). For winding, the projection may be changed such that the normals are pointing outward (e.g., by flipping the triangle using a formula provided).

In the step 208, scaling is implemented to adjust the size of the triangle. Any implementation of scaling is able to be used.

In the step 210, guttering is performed which adds a distance/buffer around the triangle such that there is space between each triangle (also referred to as a patch).

In the step 212, patch rotation occurs such that the triangle is rotated. For patch rotation, sizeU and sizeV are used, where sizeU and sizeV are the quantized version of the bounding box. In some instances, the bounding box may not be an appropriate size for the patch. For example, if a triangle is rotated, part of the triangle is outside the bounding box (e.g., outside 0 to 1). When placed on the texture map, the triangle point may fall outside of the UV range. In some instances, to patches may collide with each other.

In the step 214, patch translation occurs. Patch rotation and translation are implemented to ensure the patch fits appropriately in the texture map. For patch translation, U0 and V0 are used, where U0 and V0 indicate the position in the texture map.

In some embodiments, the order of the steps is modified. In some embodiments, fewer or additional steps are implemented.

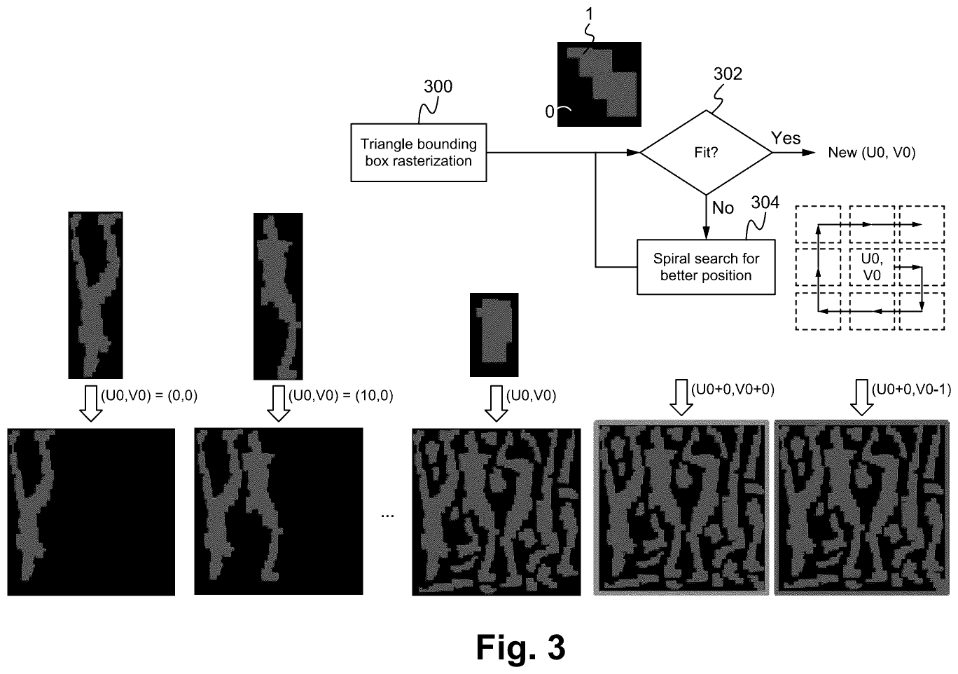

FIG. 3 illustrates a diagram of orthoAtlas UV correction according to some embodiments. To address the issue of the triangle/patch being outside the texture map, a U0, V0 adjustment is implemented. In the step 300, triangle bounding box rasterization is performed. Rasterization includes determining which pixels are 1 or 0 (occupied or not). For example, in the exemplary image, the black pixels are 0 (not occupied), and the gray pixels are 1 (occupied). Then, in the step 302, it is determined if the patch fits in the texture map. To determine if the patch fits, it is determined if there is any overlap with another patch. If the patch does not fit, then a spiral search around the current position (U0, V0) is implemented to search for a position where the patch does fit, in the step 304. For example, a position to the side is completely off the texture map. However, eventually a position where the patch is on the texture map entirely is able to be found, which is the new U0, V0 position. When the patch fits on the texture map, then that U0, V0 is used.

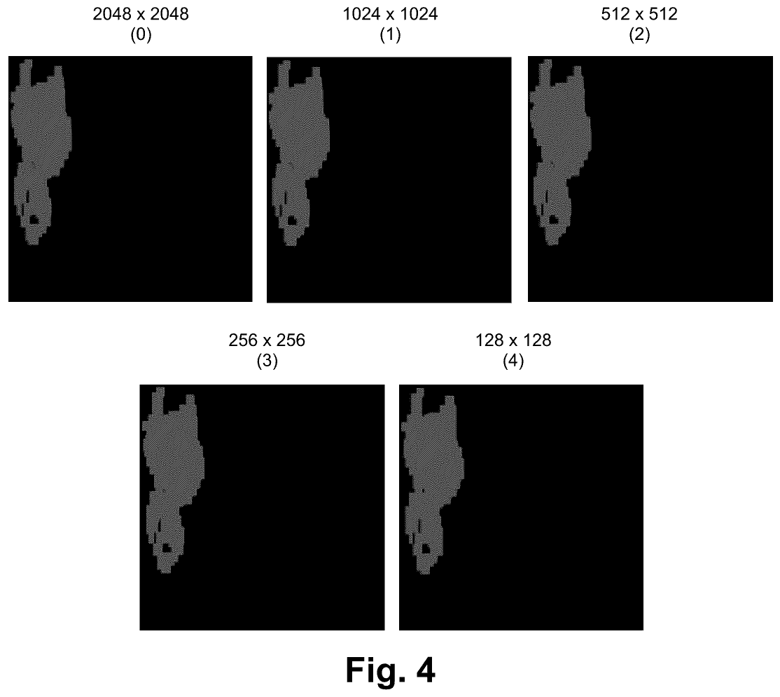

FIG. 4 illustrates images of varying resolution according to some embodiments. The analysis of the triangle bounding box rasterization would take a long time with high resolution (2048×2048). To be more efficient (e.g., a faster search), instead of going pixel by pixel, blocks are able to be used such as blocks of 2×2, 4×4, 8×8 or 16×16 pixels. By using larger blocks, the size of the image shrinks and the contours become slightly more jagged (e.g., loss of detail).

Without the orthoAtlas UV corrections, there were many frames with out-of-range UV coordinates. With an adjustment of resolution=0, only two frames contained values out of range, and with an adjustment of resolution=2 or 4, only a single frame contained values out of range for each.

orthoAtlas Inter

Previously, projection parameters were sent for every frame. For frames that are the same or very similar to each other, it would be efficient to indicate that. An added syntax allows the projection parameters from a previous frame to be used again (e.g., for the current frame).

For INTER patches, all new projection parameters are sent by disabling delta_enable_flag, or some parameters are able to be sent as delta information by enabling delta_enable_flag, and indicating for each subpatch (e.g., projection parameter) if it is an update sub_patch or not (update_present_flag). For delta sub-patches, the difference information is sent for position (U0, V0) and size (sizeU, sizeV) relative to a patch from a reference list. The respective face id, projection, orientation and scale present flag and scale power factor remain the same. The reference index is indicated by using the difference between the current index and the reference index.

For MERGE patches, the parameters are able to be copied from a reference patch, or the delta for patch position (U0, V0) and size (sizeU, sizeV) is indicated in case orthoAtlas changes anything. It is assumed that the number of patches and their respective projection, orientation and scale remain the same for all sub-patches. Also, the number of patches to be updated are very few or could be an encoder decision.

orthoAtlas Bounding Box

The 3D bounding box is used to remove the bias of the projected vertices, or the reverse the winding of the projected triangles. The floating-point value obtained from the decoded vertex positions is used. It may be different from the one used during texture parameterization, since vertex position may change due to geometry parameterization or compression.

The sub-patch bounding box is used to identify the sub-patch translation in the texture map image (U0,V0) and to enable sub-patch rotation. The values are quantized by the occupancy block size and transformed from floating-points to integers. The size of the sub-patch is first calculated to be larger than the size of the projected bounding box (but that may not be true, since values can change).

With the UV correction, the size of the bounding box of the sub-patch (quantized to integers) will be larger than the size of the projected bounding box (floating-point). The projected bounding box is able to substitute the values for the quantized sub-patch bounding box.

This way, the transmission of sub-patch sizeU and sizeV syntax elements is avoided.

orthoAtlas Simplification

A method to remove the bounding box calculation requirement at the decoder for orthoAtlas is described. New syntax elements to represent the bounding box bias are included, and therefore remove the need to calculate the bounding box on the decoder side.

The basemesh is decoded, and the bounding box is calculated, to have the projection parameters to reconstruct the texture coordinates. This causes a dependency between the orthoAtlas homography transform and the basemesh decoding.

It is optional to remove the calculation of the bounding box to generate the homography transform.

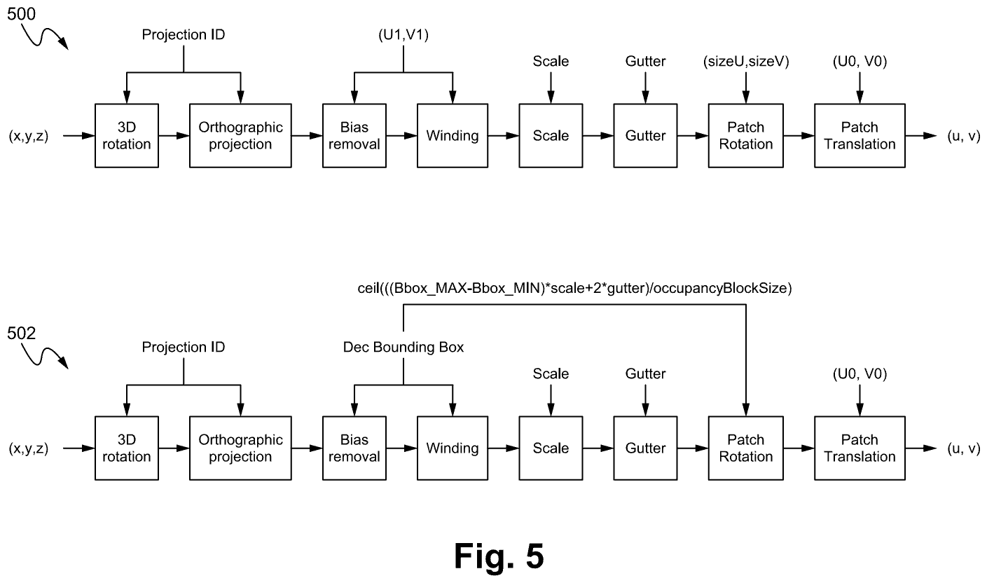

FIG. 5 illustrates a diagram of the orthoAtlas simplification according to some embodiments. In 500, the quantized information is sent, but the decoding bounding box is not calculated. U1, V1 is sent and used to perform the bias removal and winding. In 502, the bounding box is not sent; rather, a decoding bounding box is used in conjunction with a formula.

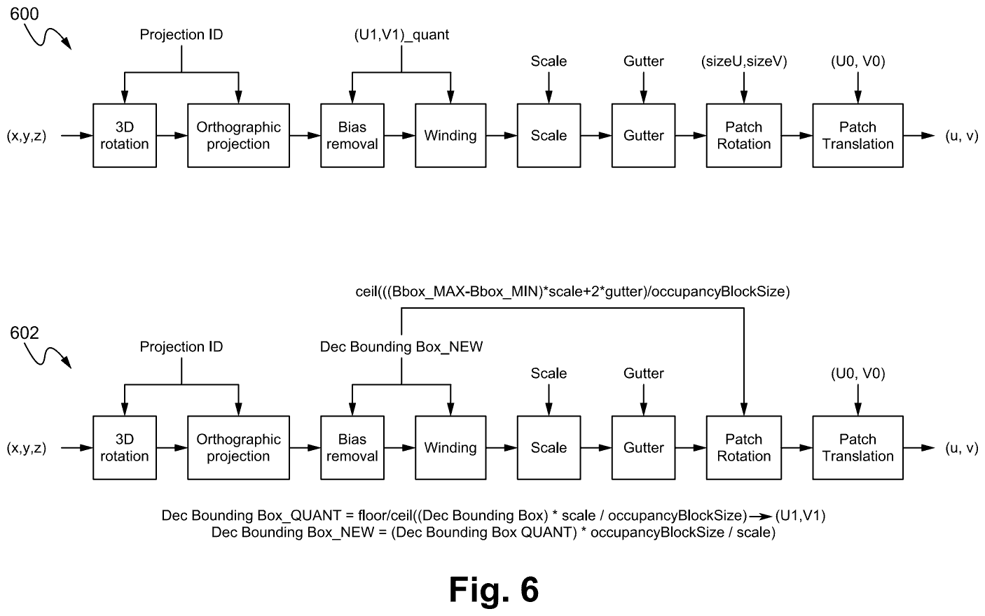

FIG. 6 illustrates a diagram of the orthoAtlas simplification according to some embodiments. In 600, quantization is applied to U1, V1 to avoid having to send very large numbers. In 602, quantization is applied to the decoding bounding box.

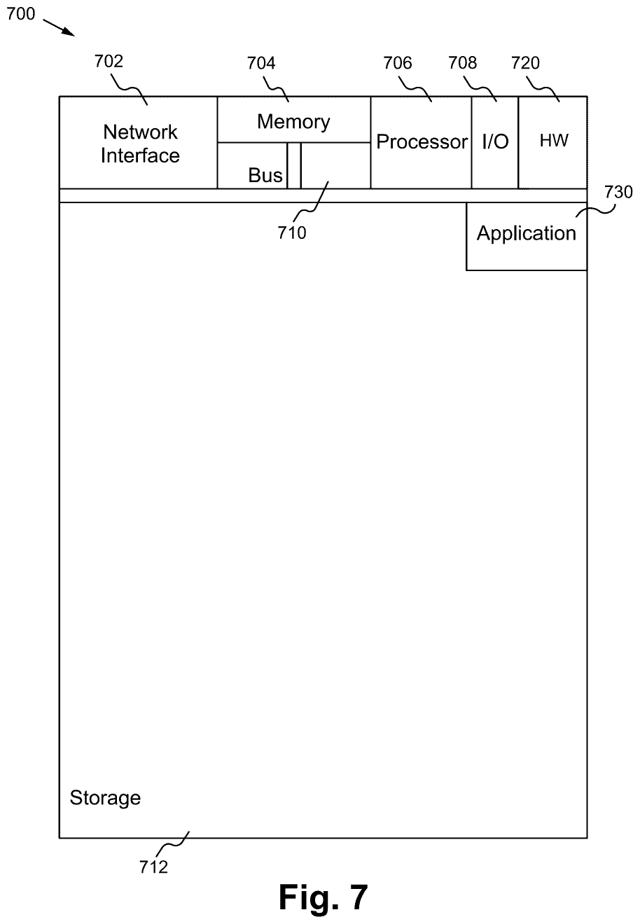

FIG. 7 illustrates a block diagram of an exemplary computing device configured to implement the orthoAtlas optimization methods according to some embodiments. The computing device 700 is able to be used to acquire, store, compute, process, communicate and/or display information such as images and videos. The computing device 700 is able to implement any of the orthoAtlas optimization aspects. In general, a hardware structure suitable for implementing the computing device 700 includes a network interface 702, a memory 704, a processor 706, I/O device(s) 708, a bus 710 and a storage device 712. The choice of processor is not critical as long as a suitable processor with sufficient speed is chosen. The memory 704 is able to be any conventional computer memory known in the art. The storage device 712 is able to include a hard drive, CDROM, CDRW, DVD, DVDRW, High Definition disc/drive, ultra-HD drive, flash memory card or any other storage device. The computing device 700 is able to include one or more network interfaces 702. An example of a network interface includes a network card connected to an Ethernet or other type of LAN. The I/O device(s) 708 are able to include one or more of the following: keyboard, mouse, monitor, screen, printer, modem, touchscreen, button interface and other devices. OrthoAtlas optimization application(s) 730 used to implement the orthoAtlas optimization methods are likely to be stored in the storage device 712 and memory 704 and processed as applications are typically processed. More or fewer components shown in FIG. 7 are able to be included in the computing device 700. In some embodiments, orthoAtlas optimization hardware 720 is included. Although the computing device 700 in FIG. 7 includes applications 730 and hardware 720 for the orthoAtlas optimization methods, the orthoAtlas optimization methods are able to be implemented on a computing device in hardware, firmware, software or any combination thereof. For example, in some embodiments, the orthoAtlas optimization applications 730 are programmed in a memory and executed using a processor. In another example, in some embodiments, the orthoAtlas optimization hardware 720 is programmed hardware logic including gates specifically designed to implement the orthoAtlas optimization methods.

In some embodiments, the orthoAtlas optimization application(s) 730 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

To utilize the orthoAtlas optimization methods described herein, a device acquires or receives 3D content (e.g., point cloud content). The orthoAtlas optimization methods are able to be implemented with user assistance or automatically without user involvement.

In operation, the orthoAtlas optimization methods improve the efficiency of orthoAtlas in terms of speed and bandwidth usage.

### Some Embodiments of New Syntax Elements and Optimization Methods for Orthoatlas

1. A method programmed in a non-transitory memory of a device comprising:
   implementing at least one of:
   indicating a mapping method used by orthoAtlas;
   adjusting projection parameters to compensate for compression artifacts in encoded vertex positions;
   encoding projection parameters based on temporal correlation;
   using a calculated bounding box to derive projection parameters; and
   avoiding bounding box estimation at a decoder.
2. The method of clause 1 wherein indicating the mapping method includes attributes selected from uv coordinates, face ID, and when no attribute is indicated, connected components are utilized.
3. The method of clause 1 wherein adjusting projection parameters includes using projection parameters by searching in 2D to readjust the projection parameters to avoid having values outside of a range or values on top of each other.
4. The method of clause 1 wherein encoding projection parameters based on temporal correlation includes copying data from a reference patch.
5. The method of clause 1 wherein encoding projection parameters based on temporal correlation includes sending delta information.
6. The method of clause 1 wherein adjusting projection parameters includes performing triangle bounding box rasterization.
7. The method of clause 6 wherein adjusting projection parameters includes determining if a patch fits in a texture map by determining if there is any overlap with another patch.
8. The method of clause 7 wherein when the patch is determined to not fit, a spiral search around a current position is implemented to search for a position where the patch fits.
9. The method of clause 7 wherein blocks of a plurality of pixels are used in the triangle bounding box rasterization.
10. An apparatus comprising:
   a non-transitory memory for storing an application, the application for:
      implementing at least one of:
         indicating a mapping method used by orthoAtlas;
         adjusting projection parameters to compensate for compression artifacts in encoded vertex positions;
         encoding projection parameters based on temporal correlation;
         using a calculated bounding box to derive projection parameters; and
         avoiding bounding box estimation at a decoder; and
   a processor coupled to the memory, the processor configured for processing the application.
11. The apparatus of clause 10 wherein indicating the mapping method includes attributes selected from uv coordinates, face ID, and when no attribute is indicated, connected components are utilized.
12. The apparatus of clause 10 wherein adjusting projection parameters includes using projection parameters by searching in 2D to readjust the projection parameters to avoid having values outside of a range or values on top of each other.
13. The apparatus of clause 10 wherein encoding projection parameters based on temporal correlation includes copying data from a reference patch.
14. The apparatus of clause 10 wherein encoding projection parameters based on temporal correlation includes sending delta information.
15. The apparatus of clause 10 wherein adjusting projection parameters includes performing triangle bounding box rasterization.
16. The apparatus of clause 15 wherein adjusting projection parameters includes determining if a patch fits in a texture map by determining if there is any overlap with another patch.
17. The apparatus of clause 16 wherein when the patch is determined to not fit, a spiral search around a current position is implemented to search for a position where the patch fits.
18. The apparatus of clause 16 wherein blocks of a plurality of pixels are used in the triangle
   bounding box rasterization.
19. A system comprising:
   an encoder configured for:
      indicating a mapping method used by orthoAtlas;
      adjusting projection parameters to compensate for compression artifacts in encoded vertex positions;
      encoding projection parameters based on temporal correlation; and
      using a calculated bounding box to derive projection parameters; and a decoder configured for avoiding bounding box estimation.
20. The system of clause 19 wherein indicating the mapping method includes attributes selected from uv coordinates, face ID, and when no attribute is indicated, connected components are utilized.
21. The system of clause 19 wherein adjusting projection parameters includes using projection parameters by searching in 2D to readjust the projection parameters to avoid having values outside of a range or values on top of each other.
22. The system of clause 19 wherein encoding projection parameters based on temporal correlation includes copying data from a reference patch.
23. The system of clause 19 wherein encoding projection parameters based on temporal correlation includes sending delta information.
24. The system of clause 19 wherein adjusting projection parameters includes performing triangle bounding box rasterization.
25. The system of clause 24 wherein adjusting projection parameters includes determining if a patch fits in a texture map by determining if there is any overlap with another patch.
26. The system of clause 25 wherein when the patch is determined to not fit, a spiral search around a current position is implemented to search for a position where the patch fits.
27. The system of clause 25 wherein blocks of a plurality of pixels are used in the triangle bounding box rasterization.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
implementing at least one of:
indicating a mapping method used by orthoAtlas;
adjusting projection parameters to compensate for compression artifacts in encoded vertex positions;
encoding projection parameters based on temporal correlation;
using a calculated bounding box to derive projection parameters; and
avoiding bounding box estimation at a decoder.

2. The method of claim 1 wherein indicating the mapping method includes attributes selected from uv coordinates, face ID, and when no attribute is indicated, connected components are utilized.

3. The method of claim 1 wherein adjusting projection parameters includes using projection parameters by searching in 2D to readjust the projection parameters to avoid having values outside of a range or values on top of each other.

4. The method of claim 1 wherein encoding projection parameters based on temporal correlation includes copying data from a reference patch.

5. The method of claim 1 wherein encoding projection parameters based on temporal correlation includes sending delta information.

6. The method of claim 1 wherein adjusting projection parameters includes performing triangle bounding box rasterization.

7. The method of claim 6 wherein adjusting projection parameters includes determining if a patch fits in a texture map by determining if there is any overlap with another patch.

8. The method of claim 7 wherein when the patch is determined to not fit, a spiral search around a current position is implemented to search for a position where the patch fits.

9. The method of claim 7 wherein blocks of a plurality of pixels are used in the triangle bounding box rasterization.

10. An apparatus comprising:
a non-transitory memory for storing an application, the application for:
implementing at least one of:
indicating a mapping method used by orthoAtlas;
adjusting projection parameters to compensate for compression artifacts in encoded vertex positions;
encoding projection parameters based on temporal correlation;
using a calculated bounding box to derive projection parameters; and
avoiding bounding box estimation at a decoder; and
a processor coupled to the memory, the processor configured for processing the application.

11. The apparatus of claim 10 wherein indicating the mapping method includes attributes selected from uv coordinates, face ID, and when no attribute is indicated, connected components are utilized.

12. The apparatus of claim 10 wherein adjusting projection parameters includes using projection parameters by searching in 2D to readjust the projection parameters to avoid having values outside of a range or values on top of each other.

13. The apparatus of claim 10 wherein encoding projection parameters based on temporal correlation includes copying data from a reference patch.

14. The apparatus of claim 10 wherein encoding projection parameters based on temporal correlation includes sending delta information.

15. The apparatus of claim 10 wherein adjusting projection parameters includes performing triangle bounding box rasterization.

16. The apparatus of claim 15 wherein adjusting projection parameters includes determining if a patch fits in a texture map by determining if there is any overlap with another patch.

17. The apparatus of claim 16 wherein when the patch is determined to not fit, a spiral search around a current position is implemented to search for a position where the patch fits.

18. The apparatus of claim 16 wherein blocks of a plurality of pixels are used in the triangle bounding box rasterization.

19. A system comprising:
an encoder configured for:
indicating a mapping method used by orthoAtlas;
adjusting projection parameters to compensate for compression artifacts in encoded vertex positions;
encoding projection parameters based on temporal correlation; and
using a calculated bounding box to derive projection parameters; and
a decoder configured for avoiding bounding box estimation.

20. The system of claim 19 wherein indicating the mapping method includes attributes selected from uv coordinates, face ID, and when no attribute is indicated, connected components are utilized.

21. The system of claim 19 wherein adjusting projection parameters includes using projection parameters by searching in 2D to readjust the projection parameters to avoid having values outside of a range or values on top of each other.

22. The system of claim 19 wherein encoding projection parameters based on temporal correlation includes copying data from a reference patch.

23. The system of claim 19 wherein encoding projection parameters based on temporal correlation includes sending delta information.

24. The system of claim 19 wherein adjusting projection parameters includes performing triangle bounding box rasterization.

25. The system of claim 24 wherein adjusting projection parameters includes determining if a patch fits in a texture map by determining if there is any overlap with another patch.

26. The system of claim 25 wherein when the patch is determined to not fit, a spiral search around a current position is implemented to search for a position where the patch fits.

27. The system of claim 25 wherein blocks of a plurality of pixels are used in the triangle bounding box rasterization.
